(19) United States
(12) Patent Application Publication
(10) Pub. No.: US 2026/0343150 A1
(43) Pub. Date: Oct. 29, 2026

(54) Combining spatialisation techniques for audio reproduction

(71) Applicant: Bang & Olufsen A/S, Struer (DK)

(72) Inventor: Jakob Dyreby, Struer (DK)

(73) Assignee: Bang & Olufsen A/S, Struer (DK)

(21) Appl. No.: 19/662,610

(22) Filed: Apr. 29, 2026

(30) Foreign Application Priority Data
Apr. 29, 2025 (EP) 25173366.3

(51) Int. Cl. H04R 3/14; H04R 5/02; H04S 7/00

(52) U.S. Cl. CPC H04R 3/14; H04R 5/02; H04S 7/302; H04S 2400/11

(57) ABSTRACT

Disclosed is a computer-implemented method of processing audio to be played back by an audio system in a listening environment comprising a desired listening position and a wall, the audio system comprising a plurality of speaker units, wherein the method comprises receiving an audio signal to be played back. Further disclosed is an audio processing device for processing an audio signal to be played back by an audio system, an audio system for playing back an audio signal in a listening environment, the audio system comprising a plurality of speaker units and the audio processing device, and a computer program product comprising program code means adapted to cause a processing unit to perform the steps of the method.

### CROSS-REFERENCE TO RELATED APPLICATIONS

The present application claims the benefit of and priority to European Patent (EP) Application no. 25173366, filed on 29 Apr. 2025, the contents of which is incorporated herein by reference in its entirety.

### TECHNICAL FIELD

The present disclosure relates to playback of audio and in particular to a computer-implemented method of playing back audio, an audio processing device, an audio system, and a computer programme product.

### BACKGROUND

When playing back audio, it remains a general desire to spatialise the acoustic sources in the audio to allow for these to be perceived as originating from different locations than the location of the loudspeaker units reproducing the audio. As an example, for stereo audio, the acoustic sources are generally spatialised to obtain a spatial location, for instance to be distributed on a, typically horizontal, left-right axis relative to a listener. Similarly, for surround audio, such as 5.1 or 7.1 channel surround audio, acoustic sources are generally spatialised to be distributed on a, typically horizontal, plane and for object-based audio, such as Dolby Atmos audio, acoustic sources are spatialised to be distributed across a three-dimensional space.

Generally, when reproducing spatialised audio, the loudspeaker unit positions are limiting to the spatialisation of the acoustic sources. For instance, for a stereo audio signal, the distance between a left and a right loudspeaker unit relative to a distance of the listener may be limiting to the possible width, i.e. the outermost location of acoustic sources. Similarly, it has traditionally been necessary to have loudspeaker units located laterally and behind the listener for surround sound and above and below a user for object-based spatial audio.

Recently, techniques have been developed to allow smaller audio systems, such as soundbars or the like, which do not have loudspeaker units surrounding a listener, to further spatialise the audio.

An example of a such spatialisation technique is crosstalk cancellation. In crosstalk cancellation, audio is generally processed, so that sound pertaining to an acoustic source from one loudspeaker unit is partially cancelled or altered at the eardrum of the listener by means of audio from another loudspeaker unit to give a listener a perception of an acoustic source located elsewhere. For instance, in a stereo setup, sound from a left speaker to a left and right eardrum may be altered by sound from a right speaker to the eardrums to give the listener the impression of an acoustic source occurring further from the left than the left speaker. For such crosstalk cancellation techniques, however, head-related transfer functions, HRTFs, generally need to be applied to provide sufficient spatialisation. Such HRTFs are, however, individual. In particular for higher frequencies, the pinna, which varies from person to person, has a larger influence for the individual listener.

Another example of a spatialisation technique is active beamforming, in which a desired sound pressure is determined at various places in the room relative to the loudspeaker units so as to provide a desired spatialisation of the acoustic sources. Active beamforming often utilises reflections of audio on surfaces in the listening environment. Often, to rely on such reflection, a rather large amount of acoustic power is needed to overcome the human spatial consideration resulting of the interaural time difference, i.e., the law of the first soundwave. Furthermore, active beamforming is generally adapted to a specific location and orientation of a listener, causing diminished or no spatialisation if the user moves.

### SUMMARY

It, thus, remains an object of the present disclosure to overcome at least some of the abovementioned drawbacks.

According to a first aspect of the disclosure, there is provided a computer-implemented method of processing audio to be played back by an audio system in a listening environment comprising a desired listening position, the audio system comprising a plurality of speaker units, wherein the method comprises:
receiving an audio signal to be played back,
wherein the method further comprises the steps of:
dividing the audio signal into a first, lower frequency band and a second, higher frequency band;
generating, for each of the plurality of speaker units, a respective crosstalk cancellation audio signal by applying a crosstalk cancellation processing to the first, lower frequency band of the audio signal;
generating, for each of the plurality of speaker units, a respective beamforming audio signal by applying an active beamforming processing to the second, higher frequency band of the audio signal; and
outputting the crosstalk cancellation audio signals and beamforming audio signals for each of the plurality of speaker units for playback,
wherein the crosstalk cancellation processing and the active beamforming processing is applied based on location information indicating a location of the intended listening position in the listening environment relative to the plurality of speaker units.

It has been realised that by utilising crosstalk cancellation for the first, lower frequency band of the audio signal and active beamforming processing for the second, higher frequency band of the signal, an improved and more efficient spatialisation of acoustic sources in the audio signal may be provided. In particular, it has been realised that by using crosstalk cancellation for a lower frequency band, where the influence of the individual pinna of a listener is limited, a generic head-related transfer function, HRTF, can be used for this frequency band. This, in turn, alleviates the need of obtaining a custom HRTF for each listener to obtain the desired spatialisation and further provides an increased flexibility as multiple listeners may utilise the audio system without requiring a reconfiguration of this.

Furthermore, by applying beamforming signal processing to the second, higher frequency band while applying crosstalk cancellation to the first, lower frequency band, an improved spatialisation may be obtained. In particular, for the second, higher frequency band, a beamforming may require less power due to the general increasing directivity of loudspeaker units at higher frequencies. Thus, the power needed to form, e.g., reflections from surfaces of the listening environment may be less at higher frequencies, in turn allowing for a more efficient audio playback and an improved spatialisation.

By spatialisation may herein generally be understood to process the audio signal(s) to locate or arrange acoustic sources thereof or therein at various locations in the listening environment, including converting or processing spatialisation data in the audio signal. Spatialisation, thus, refers to the process of playing back, by the plurality of loudspeaker units, the audio in the listening environment so that acoustic sources in or of the audio signal appear to be located at respective positions, including positions different from the location of the plurality of loudspeaker units, in the listening environment.

By audio signal may herein be understood an audio signal for playback or a decoded audio signal, such as an audio signal downstream of a stereo, surround, or spatial audio, such as a Dolby Atmos, decoder. Correspondingly, an audio signal may be a multi-channel or multi-object audio signal and/or may be an audio signal comprising a set of channels for each of the plurality of loudspeaker units. The audio signal may be a digital signal.

Throughout the present specification, the terms loudspeaker, loudspeaker unit, speaker, and speaker units may be used interchangeably, all referring to the loudspeaker unit. It will be appreciated that the loudspeaker unit may be any electroacoustic transducer for reproducing audio as mechanical audio from an electrical signal. The term “loudspeaker unit” is, thus, not limited to an electrodynamic loudspeaker but may equally encompass or refer to any of a magnetostatic or electrostatic loudspeaker, a tweeter, a ribbon, a horn driver, or the like. Correspondingly, any loudspeaker unit may be configured to represent the full audible audio range, i.e. approximately 20 Hz to 20,000 Hz, or a subset thereof. In particular, any loudspeaker unit may be a full-tone driver, a bass driver, a mid-tone driver, a tweeter, combinations, or the like.

The intended listening position may be a location relative to the plurality of loudspeaker units in the listening environment. The intended listening position may be a location, in which a listener would often or typically be located in the listening environment.

Alternatively or additionally, the intended listening position may be a predetermined location, such as a predetermined intended listening position, in the listening environment. The intended listening position or predefined intended listening position may be defined during a setup procedure of an audio system.

The location information indicating the intended listening position may be or comprise a room response, such as a room impulse response, obtained at the intended listening position. Alternatively or additionally, the location information may be or comprise any of a room map or room dimensions, a distance from the plurality of loudspeaker units, such as from each of the plurality of loudspeaker units to the intended listening position, information about a number of surfaces in the listening environment, such as their location relative to the plurality of loudspeaker units, such as relative to each of the of the plurality of loudspeaker units, an acoustic response, or an acoustic reflection of the surface. Such surfaces may, for instance, be walls.

In some embodiments, the listening environment may comprise at least one wall or acoustically reflecting surface, i.e. a surface at least partly reflecting audio.

One or more of the beamforming audio signals, such as each beamforming audio signal, may be indicative of sound to be reflected off the at least one wall when output or played back by the plurality of speaker units. Alternatively or additionally, the active beamforming processing may comprise processing the audio to generate audio signals indicative of sound, such as at least one sound beam, to be reflected off the wall. Sound and/or sound beams to be reflected off the wall may be sound and/or sound beams to be reflected off the wall prior to arriving at the intended listening position.

By sound may generally herein be understood sound generated by the loudspeaker units by outputting the audio signals for playback. Sound, correspondingly, generally refers to a sound pressure caused by the output or playback by the loudspeaker units of the audio signals and may be in the form of sound waves, such as sound beams.

By the, e.g. beamforming, audio signals being indicative of sound to be reflected off the at least one wall when output or played back by the plurality of speaker units may herein be understood that the audio signals are indicative of, cause, give rise to, and/or result in sound being reflected off the at least one wall when output or played back by some or all of the plurality of speaker units.

Thereby, the user may perceive the reflected sound and/or sound beams, i.e. the sound and/or sound beams to be reflected off the wall, as arriving from an angle corresponding to an incident angle of the reflection. Thereby, an increased spatialisation may be achieved as a user in the intended listening position would perceive a larger width by the incident angle of the reflected sound.

The wall may be a side wall of the listening environment. The side wall may be lateral or arranged laterally with respect to a direct route or distance between the intended listening position and the audio system. For instance, in a rectangular room, the audio system may be arranged at or adjacent to a first wall, opposite of which a second wall is arranged. In between the first and second walls is the intended listening position. Further, in a such rectangular room, two side walls extend between the first and second walls on either (lateral) side of the intended listening position.

The listening environment may comprise a plurality of walls, such as two side walls. Correspondingly, the beamforming audio signals may be indicative of sound to be reflected off each wall when output or played back by the plurality of speaker units. Alternatively or additionally, the active beamforming processing may comprise processing the audio to generate beamforming audio signals indicative of sound, such as a least one respective sound beam, to be reflected off each of the walls. Sound and/or sound beams to be reflected off the walls may be sound and/or sound beams to reflect off the walls prior to arriving at the intended listening position.

The reflection(s), i.e. the reflected sound and/or sound beams, may be provided to be perceived at the intended listening location of a user as arriving from an angle of less than 90 degrees relative to a centre plane, i.e. relative to mono sound, such as from an angle of 10-85 degrees, such as from an angle of 15-80 degrees, such as from an angle of 20-75 degrees. Alternatively or additionally, the reflection(s) may be provided to be perceived at the intended listening location, i.e. by a user at the intended listening location, as arriving from an azimuth of more than −90 and less than 90 degrees, such as from −80 to 80 degrees, such as from −70 to 70 degrees, such as from −60 to 60 degrees, such as from −50 to 50 degrees. By the reflection(s) being provided may herein be understood that the active beamforming processing may be configured to process the audio to generate the beamforming audio signals indicative of or causing the reflection(s) when output by the plurality of speaker units.

It will be appreciated that outputting by the plurality of speaker units may comprise any one or more of summarising the crosstalk and beamforming audio signals, converting, such as digital-to-analogue or up- or down-sampling, the crosstalk and/or beamforming audio signals, amplifying the crosstalk and beamforming audio signals, optionally subsequent to any summarising and/or conversion. Where an amplification takes place, the amplified crosstalk and beamforming audio signals may be provided to an acoustic driver to cause sound, i.e. a sound pressure, e.g. in the form of sound waves and/or sound beams, to be generated.

The reflection(s), e.g. the reflected sound and/or sound beams, may be first-order reflection, such as a first order reflection(s) of the sound and/or sound beams.

The active beamforming processing may take into account and/or aim at providing audio signals relying on reflections. Alternatively or additionally, the active beamforming processing may process the second, higher frequency audio band of the audio signal to generate beamforming audio signals which, e.g. when the beamforming audio signals are played back by the plurality of loudspeakers, cause sound generated due to the playback of the beamforming audio signals to be reflected off the walls in the listening environment, e.g. prior to the sound arriving at or being perceived at the intended listening position.

The location information may comprise information indicative of the wall, at least relative to listening position and audio system, such as one or more of the plurality of speaker units.

The method may alternatively or additionally include a step of defining or determining the, optionally predetermined, intended listening position in the listening environment. A potential step of defining the (predetermined) intended listening position may comprise arranging the plurality of speaker units in the listening environment and receiving, from a sensor, sensor data indicating the (predetermined) intended listening position in the listening environment. The sensor data may be used as location information. The sensor may be or comprise a microphone arranged in the (predetermined) intended listening position and the sensor signal may be or comprise a microphone signal recording sound of a signal reproduced by the plurality of loudspeaker units in the listening environment. The microphone signal may be indicative of a wall response of a wall of the listening environment and/or a room response of the listening environment. Alternatively or additionally, the sensor may be or comprise a visual sensor, such as a camera, a distance sensor, or the like. Correspondingly, the sensor signal may be an image, a distance measurement, or the like.

The intended listening position may alternatively be denoted a desired listening position, a predetermined desired listening position, and/or a predetermined listening position.

The listening environment may be any space in which the plurality of loudspeaker units are arranged, such as an indoor space, e.g., a room. The listening environment may comprise at least one wall and, in some embodiments, comprise a plurality of walls, a floor, and/or a ceiling.

By wall is throughout this specification to be understood a substantially acoustically reflecting or acoustically reflecting surface for at least some frequencies of the audio signal, i.e. some frequencies in the range from 20 Hz to 20 kHz.

The crosstalk cancellation processing and the active beamforming processing may be applied based on the location information indicating the location of the intended listening position in the listening environment relative to the plurality of speaker units as well as orientation information indicating one or more of an intended listening orientation and/or a current orientation of a listener located in the intended listening position. The intended listening orientation or current orientation may be an intended or current orientation of a head of a listener, such as an orientation of the listener and/or a relative location of each of the ears of the listener.

The intended listening orientation may be a predetermined intended listening orientation. Alternatively or additionally, orientation information indicating a current orientation of the listener located in the intended listening position may be obtained via one or more sensors, such as a visual sensor, e.g. a camera, or the like, optionally periodically or continuously.

In some examples, the intended listening position may be in front, such as in front and centre, of the plurality of loudspeaker units and, optionally, the intended orientation may be towards the plurality of loudspeaker units, e.g. so that a gaze of a listener in the intended listening position is towards the loudspeaker units.

The crosstalk cancellation processing and the active beamforming processing may be based on a desired location of one or more audio sources in the audio signal. A location of one or more audio sources in the audio signal, such as each audio source in the audio signal, may be determined based on metadata in a spatial audio signal, and/or based on audio channel information in a multichannel audio signal.

The outputting crosstalk cancellation and beamforming audio signals may include, for each of the plurality of loudspeaker units, summing the crosstalk cancellation and beamforming audio signals to a respective speaker unit signal and outputting the respective speaker unit signals to the respective loudspeaker units of the plurality of loudspeaker units.

The plurality of loudspeaker units may comprise at least one loudspeaker unit and at least one loudspeaker array, the at least one loudspeaker array comprising a plurality of array speaker units. In some embodiments, the plurality of loudspeaker units comprises at least one first loudspeaker unit, at least one second loudspeaker unit, and at least one loudspeaker array, the at least one loudspeaker array comprising a plurality of array speaker units.

Alternatively or additionally, the plurality of loudspeaker units may comprise at least one first loudspeaker unit and at least one second loudspeaker unit. The at least one first loudspeaker unit may be arranged as a side-firing loudspeaker unit, such as angled toward a first direction relative to the intended listening position. Alternatively or additionally, the at least one second loudspeaker unit may be arranged as a side-firing loudspeaker unit, such as angled toward a second direction relative to the intended listening position. The first and/or second directions may be different from a direction of a direct or shortest path between the at least one first loudspeaker unit and/or the at least one second loudspeaker unit, respectively. The first and second directions may be different directions, optionally with an angle between the first and second directions of at least 15 degrees, such as at least 30 degrees, such as at least 45 degrees, such as at least 60 degrees, such as at least 75 degrees, such as at least 90 degrees.

The at least one first speaker unit may be arranged at a first side, such as a left-hand side, of the intended listening position in the listening environment, optionally when the listener has the predetermined listening orientation.

The at least one second speaker unit may be arranged at a second side, such as a right-hand side, of the intended listening position in the listening environment, optionally when the listener has the predetermined listening orientation.

Where the plurality of speaker units comprises at least one loudspeaker array, the plurality of array speaker units may comprise a first array speaker unit and a second array speaker unit. The first array speaker unit may be arranged to project sound towards the first side to provide a beam of sound to be reflected by a first side wall of the listening environment. The first side wall may be arranged at the first side of the intended listening position. The second array speaker unit may be arranged to project sound towards the second side to provide a beam of sound to be reflected by a second side wall of the listening environment. The second side wall may be arranged at the second side of the intended listening position. The second side may be opposite the first side.

Alternatively or additionally, the plurality of loudspeakers, such as the at least one loudspeaker array, may be configured to provide a beam of sound to be reflected by a first side wall of the listening environment, wherein the beam corresponds to, i.e. is generated or reproduced by the respective loudspeaker(s) based on, at least a portion of the beamforming audio signals. The beam of sound to be reflected may comprise, such as substantially consist of and/or consist of, audio in the second, higher frequency range.

In other words, active beamforming processing may be applied so that the high-frequency content is or is to be reflected off the wall(s) when played back by the plurality of loudspeakers, such as the at least one loudspeaker array.

It will be appreciated that the loudspeaker array may be any type of loudspeaker array, including a line array, comprising a plurality of loudspeaker units arranged adjacent to each other and arranged approximately in a parallel direction, a multiactuator array, a circular array or any combination thereof.

Any array of the plurality of loudspeaker units may comprise a plurality of array speaker units, which are collocated, i.e. located so that a distance, at least in one plane, between sound-emitting surfaces of two adjacent array speaker units is less than or equal to half a wavelength of an upper frequency, which the speaker unit is to reproduce. For instance, where an array comprises a tweeter to reproduce audio up to 20,000 Hz, i.e. having a wavelength of approximately 1.7 cm, the tweeter should be located to have its sound emitting surface within 0.85 cm from the adjacent array speaker unit. In order to do so, the tweeter may be arranged vertically above or below the adjacent array speaker unit to provide a distance of up to 0.85 cm, at least within a horizontal plane.

A collocated plurality of array speaker units may be arranged centrally with respect to the intended listening position, such as directly in front of the intended listening position and/or symmetrically around a centre of the intended listening position.

The intended listening position may define a centre plane of the listening environment, the centre plane defining a centre, such as a geometric centre, between a left and right ear of a listener located in the predetermined intended listening position.

The centre plane may be a vertical plane.

The first speaker unit may be arranged on a first side, such as a left-hand side when seen from the perspective of a listener located in the predetermined listening position, of the centre plane. A left ear of a listener located in the predetermined listening position may, correspondingly, be located on the same first side of the centre plane. The second speaker unit may be arranged on a second side, such as a right-hand side when seen from the perspective of a listener located in the predetermined listening position, of the centre plane. A right ear of a listener located in the predetermined listening position may, correspondingly, be located on the same second side of the centre plane.

Alternatively or additionally, for the at least one loudspeaker array, the first array speaker unit may be arranged on the first side, such as a left-hand side when seen from the perspective of a listener located in the predetermined listening position, of the centre plane. The left ear of a listener located in the predetermined listening position may, correspondingly, be located on the same first side of the centre plane. The second array speaker unit may be arranged on the second side, such as a right-hand side when seen from the perspective of a listener located in the predetermined listening position, of the centre plane. The right ear of a listener located in the predetermined listening position may, correspondingly, be located on the same second side of the centre plane.

Any loudspeaker array may alternatively or additionally comprise upwards firing loudspeaker units of the array.

Outputting the respective signals may comprise outputting these to an amplifier circuit, a digital-analogue-converter, DAC, or to a unit for further signal processing. Alternatively or additionally, outputting the respective signals may comprise outputting the respective signals to a signal buffer.

The steps of generating the crosstalk cancellation signals and of generating the active beamforming signals may be performed in any order, such as generating the crosstalk cancellation signals prior to, subsequent to, or simultaneously, e.g. in parallel, with generating the active beamforming signals.

Alternatively or additionally, the steps of generating the crosstalk cancellation signals and the active beamforming signals may be performed by means of one or more filters, such as one or more sets of filters.

Dividing the signal into the first and second frequency bands may comprise applying a filter, such as a low-pass or band-pass filter, to the filter to obtain the first, lower frequency band and/or applying a filter, such as a band-pass filter or a high-pass filter to obtain the second, higher frequency band.

The part of the signal divided into the first, lower frequency band may alternatively be denoted a first signal portion, and the part of the signal divided into the second, higher frequency band may alternatively be denoted a second signal portion.

The first, lower frequency band may have a first, lower frequency range, which comprise signal components primarily, substantially, or exclusively in the first, lower frequency range. The second, higher frequency band may have a second, higher frequency range, which comprise signal components primarily, substantially, or exclusively in the second, higher frequency range.

It will be appreciated that the computer-implemented method may be carried out by any processing units including, but not limited to, a central processing unit (CPU), a digital signal processor (DSP), a microcontroller unit (MCU), a field-programmable gate array (FPGA), or the like. Such processing units are commonly known in the art and will, correspondingly not be described in further detail in the present specification.

In some embodiments, applying a crosstalk cancellation processing comprises:
determining a respective desired sound pressure at a respective location of a left ear drum and a right ear drum, such as each of a left ear drum and a right ear drum, of a user located in the intended listening position in accordance with a desired sound source location in the listening environment;
determining a respective sound pressure contribution to the total sound pressure at the locations of each of the left ear drum and the right ear drum of a user located in the intended listening position from each of the plurality of speaker units; and
determining a respective crosstalk cancellation weight value for each of the at least one first speaker and each of the at least one second speaker, wherein the respective crosstalk cancellation weights are determined so that a sum of the respective weights applied to the respective contributions from each of the at least one first speaker and each of the at least one second speaker approximates or equals the respective desired sound pressures at the respective locations of each of the left ear drum and the right ear drum of a user located in the intended listening position.

Thereby, a contribution from each loudspeaker unit to a perceived audio and, thus, spatialisation at the ear drum of the user may be obtained.

Alternatively or additionally, applying a crosstalk cancellation processing may comprise:
determining a set of first transfer functions comprising a respective first transfer function, H_{Di1} from each of the plurality of speaker units to a left ear drum of a listener in the intended listening position, and determining a set of second transfer functions comprising a respective second transfer function, H_{Di2} from each of the plurality of loudspeaker units to a right ear drum of a listener in the intended listening position; and
determining for each or the plurality of speaker units, a set of weights comprising a respective frequency dependent complex gain, wᵢ, to be applied to the audio signal for each respective speaker unit, wherein each frequency dependent complex gain, wᵢ, is determined so that a sum of products of, for each of the plurality of loudspeaker units, the respective weight and the respective first transfer functions, wᵢH_{Di1}, is equal to the first source transfer function, H_{S1}, and so that a sum of products of, for each of the plurality of speaker units, the respective weight and the respective second transfer function, wᵢH_{Di2}, is equal to the second source transfer function, H_{S2}.

The weight may be a complex value, such as a complex factor to be applied to the respective transfer functions. While described above in the frequency domain, it will be appreciated that this equally applies to time-domain processing.

The crosstalk cancellation processing may be implemented in the form of linear time-invariant filters, such as finite-impulse-response (FIR) or infinite-impulse-response (IIR) filters, and/or as a delay-and-sum, i.e. as a delay and gain to be summed for each signal.

In mathematical terms, the crosstalk cancellation processing may alternatively or additionally comprise determining the respective weights wᵢ for each of the plurality of speaker units, i.e. for the i'th loudspeaker:

The transfer functions from a loudspeaker unit Dᵢ to each of a left ear E_{L} and a right E_{R} of a listener are denoted H_{DiL} and H_{DiR}. The resulting transfer function from the plurality of loudspeaker units to each of the left and right ears can be described as:

$${H}_{E L} = {\sum }_{i = 1}^{N} {w}_{i} {H}_{D i L} , {H}_{E R} = {\sum }_{i = 1}^{N} {w}_{i} {H}_{D i R}$$

where wᵢ is a frequency dependent complex gain applied to the input signal before sending it to the i'th loudspeaker unit.

The desired location of the acoustic source S₁ has a transfer function to each ear denoted H_{S1L} and H_{S1R}. By determining wᵢ such that H_{EL} is equal to H_{S1L} and H_{ER} is equal to H_{S1R} the sound pressure at the ear drums of the listener will be the same as if the source was placed in the desired position.

The pressure at the respective ear drums of the left and right ears, respectively, of the listener may be determined by means of a head-related transfer function (HRTF). The HRTF may be a generic or predetermined HRTF.

In some embodiments, the active beamforming processing comprises determining, for a plurality of angular positions in the listening environment relative to the plurality of speaker units, a respective desired directivity of the plurality of speaker units;
determining, for each of the plurality of angular positions, a respective sound pressure contribution from each of the plurality of speaker units, and
determining a respective active beamforming weight for each of the plurality of speaker units so that a sound pressure in each of the plurality of directions are in accordance with the desired directivity of the plurality of speaker units.

The active beamforming processing may provide a contribution from each of the plurality of speaker units to a sound pressure at and/or transfer function to a specific direction and/or position in the listening environment relative to the plurality of speaker units and determine a set of beamforming weights to provide a desired sound pressure at and/or transfer function to the specific direction and/or position, respectively.

The determination of the respective desired sound pressure contributions, the respective crosstalk cancellation weights, and/or the respective active beamforming weights may be performed based on anechoic measurements of each of the plurality of loudspeaker units, such as each of the plurality of loudspeaker units in an audio system.

Such anechoic measurements generally refer to measurements made in an anechoic chamber and may be indicative of an impulse response and/or frequency response as a function of location and/or direction relative to each of the plurality of loudspeaker units.

Such anechoic measurements, or data indicating, for instance a response of each loudspeaker unit as a function of angle, distance, and azimuth, may be stored in a memory of an audio processing device.

The desired sound source location in the listening environment may be determined based on or as if in an anechoic environment. Alternatively or additionally, determining, for a plurality of angular positions in the listening environment relative to the plurality of speaker units, a respective desired directivity of the plurality of speaker units may be performed based on the anechoic measurements, e.g. using the anechoic measurements and/or applying a determined response from the room to the anechoic measurements.

The active beamforming processing may alternatively or additionally comprise determining transfer functions from each loudspeaker unit to a plurality of location points in the listening environment, determining a respective set of active beamforming weights for each of the loudspeaker units to obtain a desired sound pressure at and/or transfer function from each of the loudspeaker units at each of the plurality of location points in the listening environment. The location points may be positions, locations, or the like.

Alternatively or additionally, the active beamforming processing may be defined as determining a set of weights to obtain a desired pressure or transfer function fulfilling, for each of the plurality of speaker units:

$${H}_{P θ1φ1} = {\sum }_{i = 1}^{N} {w}_{i} {H}_{D i θ1φ1}$$

$${H}_{P θ2φ2} = {\sum }_{i = 1}^{N} {w}_{i} {H}_{D i θ2φ2}$$

$$…$$

$${H}_{P θ M φ M} = {\sum }_{i = 1}^{N} {w}_{i} {H}_{Di θ M φ M}$$

The transfer functions from a loudspeaker unit Dᵢ to P_{θφ} is denoted H_{Pθφ}. wᵢ may be calculated such that the resulting transfer functions and/or sound pressures are loud in desired beam directions and quiet in other directions. It may, thereby, be possible to increase the difference between the sound directed at the wall and the sound directed at the listener. When this difference is large enough, the listener will locate the sound in the position S₁.

The resulting transfer function from the plurality of loudspeaker units to a location point P_{θφ} can, thus, be described as:

$${H}_{P θφ} = {\sum }_{i = 1}^{N} {W}_{i} {H}_{Di θφ}$$

where wᵢ is a frequency dependent complex gain applied to the input signal before sending it to the i'th loudspeaker unit.

In some embodiments, the first, lower frequency band has a lower frequency of at least 100 Hz, such as at least 150 Hz, such as at least 200 Hz, such as at least 250 Hz, such as at least 300 Hz.

In some embodiments, an upper frequency of the first, lower frequency band is at least 800 Hz, such as at least 900 Hz, such as at least 1 kHz.

In some embodiments, a lower frequency of the second, higher frequency band is at least 800 Hz, such as at least 900 Hz, such as at least 1 kHz.

The lower frequency of the second, higher frequency band may be the same as an upper frequency of the first, lower frequency band. In a such instance, the identical upper frequency of the first, lower frequency band may be referred to as a crossover frequency.

Alternatively, the lower frequency of the second, higher frequency band may be lower than the upper frequency of the first, lower frequency band. The first, lower frequency band and the second, higher frequency band may have an overlapping frequency range.

Where the first, lower frequency band and the second, higher frequency ranges are overlapping or have overlapping frequency ranges, outputting the crosstalk cancellation signals and the active beamforming signals may comprise compensating, such as reducing the energy of the overlapping frequency range, by an amount.

In some embodiments, the lower frequency of the second, higher frequency band is below 5000 Hz, such as below 4000 Hz, such as below 3000 Hz, such as below 2500 Hz.

In other embodiments, the lower frequency of the second, higher frequency band may be above 10 kHz, such as above 15 kHz, such as above 20 kHz, at least for some configurations. The upper frequency of the first, lower frequency band may, correspondingly be at least 10 kHz, such as above 15 kHz, such as above 20 kHz.

In some embodiments, the audio processing unit is configured to determine the upper frequency of the first, lower frequency band and/or the lower frequency of the second, higher frequency band based on one or more of a distance from any one or more, such as each, of the plurality of loudspeaker units to the intended listening position, a distance from one or more, such as each, of the plurality of speaker units to a wall in the listening environment, a wall response from one or more walls in the listening environment of a reflection of sound from one or more, such as each, or the plurality of loudspeaker units, and a number of listeners in the listening environment.

Thereby, an improved spatialisation may be provided by depending on dynamic changes in the listening environment, such as changes in the number of loudspeaker units, movement of furniture, different seating positions, movement of the plurality of loudspeaker units, or the like.

It will be appreciated that a lower frequency of a frequency band throughout this disclosure generally denotes the lowermost frequency of the respective frequency band, such as a frequency delimiting the frequency range at the lower end thereof.

Correspondingly, an upper frequency of a frequency band throughout this disclosure generally denotes the uppermost frequency of the respective frequency band, such as a frequency delimiting the frequency range at the upper end thereof.

According to a second aspect, the present disclosure relates to an audio processing device for processing an audio signal to be played back by an audio system having a plurality of speaker units in a listening environment comprising an intended listening position, wherein the audio processing device comprises an audio processing unit configured to perform the method according the first aspect.

The audio processing device may provide identical or similar advantages as described with respect to the method of the first aspect of this disclosure. Embodiments of the audio processing device may be the same as described with respect to the method according to the first aspect of this disclosure.

The listening environment may furthermore comprise one or more walls. The listening environment may be a listening environment as described with respect to the first aspect of the disclosure.

The audio processing unit may be any of a CPU, MCU, DSP, an FPGA, or any other processing unit capable of processing audio.

In some embodiments, the audio processing device further comprises a memory, such as a non-transitory memory, operably connected to the audio processing unit. The memory may store instructions thereon which, when performed by the audio processing unit, may cause the audio processing unit to perform the method according to the first aspect. The memory may a Random Access Memory (RAM), a Read-Only Memory (ROM) type, or a Flash memory, or any other type of memory suitable for storing such instructions.

Where a memory is present, the memory may be configured to store filter coefficients corresponding to the crosstalk signal processing and/or to the active beamforming processing, optionally after an initial setup step.

According to a third aspect, the present disclosure relates to an audio system for playing back an audio signal in a listening environment, the audio system comprising:
a plurality of speaker units, and
an audio processing device according to the second aspect operably connected to the plurality of speaker units.

The audio system may provide identical or similar advantages as described with respect to the method of the first aspect of this disclosure and/or with respect to the audio processing device according to the second aspect of this disclosure. Embodiments of the audio system may be the same as described with respect to the method according to the first aspect of this disclosure and/or with respect to the audio processing device according to the second aspect of the disclosure.

The listening environment may comprise an intended listening position. The listening environment may furthermore comprise one or more walls. The listening environment may be a listening environment as described with respect to the first aspect of the disclosure.

In some embodiments, the audio system further comprises a housing, wherein the housing houses the plurality of speaker units.

The housing may alternatively or additionally be an enclosure, at least partially enclosing the plurality of speaker units.

The plurality of speaker units may be mounted in the housing, e.g. so that the housing forms a speaker enclosure.

In some embodiments, the plurality of speaker units comprises a loudspeaker array, comprising a plurality of array speaker units.

In some embodiments, the audio system is a sound bar.

According to a fourth aspect, the present disclosure relates to a computer program product comprising program code means adapted to cause a processing unit to perform the steps of the method according to the first aspect of the present disclosure, when the program code means are executed on the processing unit.

The computer programme product may provide identical or similar advantages as described with respect to the method of the first aspect of this disclosure, with respect to the audio processing device according to the second aspect of this disclosure, and/or with respect to the audio system according to the third aspect of this disclosure. Embodiments of the computer programme product may be the same as described with respect to the method according to the first aspect of this disclosure, with respect to the audio processing device according to the second aspect of this disclosure, and/or with respect to the audio system according to the third aspect of this disclosure.

In some embodiments, the computer program product comprises a non-transitory computer-readable medium having stored thereon the program code means.

A person skilled in the art will appreciate that any one or more of the above aspects of this disclosure and embodiments thereof may be combined with any one or more of the other aspects of the disclosure and embodiments thereof.

### BRIEF DESCRIPTION OF DRAWINGS

The method, audio processing unit, and audio system processing unit will now be described in greater detail based on non-limiting exemplary embodiments and with reference to the drawings, on which:

FIG. 1 shows an exemplary flow chart of an embodiment of a method according to the present disclosure,

FIG. 2 shows a schematic block diagram of an embodiment of an audio system according to the present disclosure,

FIG. 3 shows a schematic illustration of an embodiment of an audio system according to the present disclosure,

FIG. 4 shows an exemplary block diagram of an embodiment of an audio system according to the present disclosure,

FIG. 5 shows a schematic illustration of an embodiment of an audio system according to the present disclosure,

FIG. 6 shows a schematic illustration of an embodiment of an audio system according to the present disclosure,

FIG. 7 shows a schematic illustration of an embodiment of an audio system according to the present disclosure, and

FIG. 8 shows a schematic illustration of an embodiment of an audio system according to the present disclosure.

Similar reference numerals are used for similar elements across the various embodiments and figures described herein.

### DETAILED DESCRIPTION

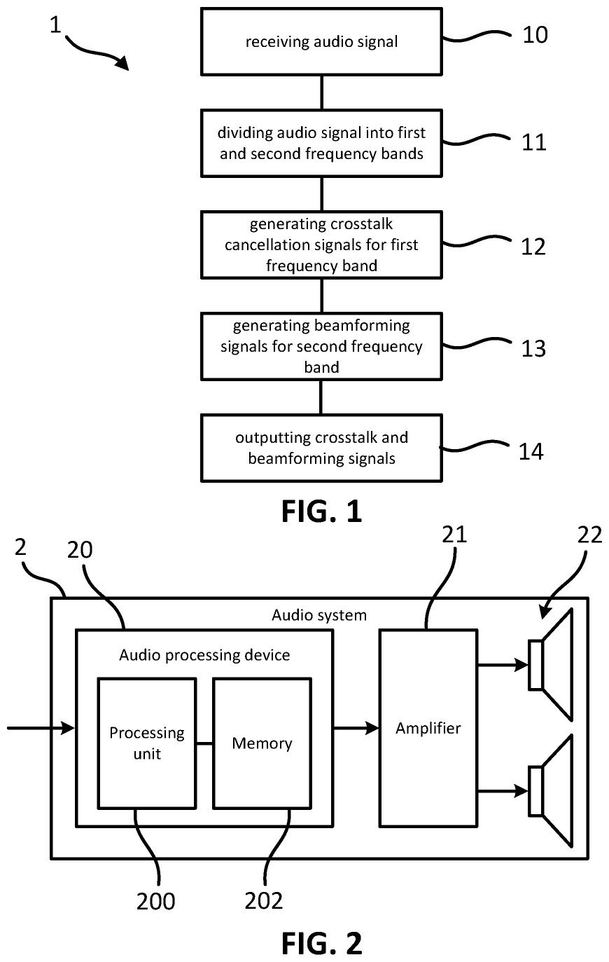

FIG. 1 shows an exemplary flow chart of an embodiment of a method 1 according to the present disclosure. The method 1 comprises the step of receiving 10 an audio signal to be played back. The method 1 further comprises the step of dividing 11 the audio signal into a first, lower frequency band and a second, higher frequency band.

The method 1 further comprises the steps of generating 12, for each of the plurality of speaker units, a respective crosstalk cancellation audio signal by applying a crosstalk cancellation processing to the first, lower frequency band of the audio signal, and generating 13, for each of the plurality of speaker units, a respective beamforming audio signal by applying an active beamforming processing to the second, higher frequency band of the audio signal. The step of generating 12 the crosstalk cancellation audio signals is illustrated as performed prior to the step of generating 13 the beamforming audio signals. In other embodiments, the steps of generating 12 the crosstalk cancellation audio signals may be performed simultaneously with or subsequently to the step of generating 13 the beamforming audio signals.

The method 1 further comprises the step of outputting 14 the crosstalk cancellation audio signals and beamforming audio signals for each of the plurality of speaker units for playback, wherein the crosstalk cancellation processing and the active beamforming processing is applied based on location information indicating a location of the intended listening position in the listening environment relative to the plurality of speaker units.

FIG. 2 shows a schematic block diagram of an embodiment of an audio system 2 according to the present disclosure. The audio system 2 comprises an audio processing device 20, comprising a processing unit 200 and a memory 202 operably connected to the processing unit 200. The processing unit 200 is configured to perform the method 1. The memory 202 comprises instructions causing the processing unit 200 to perform the steps 10-14 of method 1.

The audio system 2 further comprises an amplifier module 21 operably connected to the audio processing device 20 and to a plurality of loudspeaker units 22. The amplifier module 21 receives the signals output by the audio processing device 20 and amplifies the signal for playback and provides the amplified signal to the loudspeaker units 22.

While illustrated as one amplifier module 21, the audio system 2 may comprise a plurality of amplifier modules providing signals to one or more of the plurality of loudspeaker units 22. While two loudspeaker units are illustrated in FIG. 2, it will be appreciated that the audio system may comprise further speaker units.

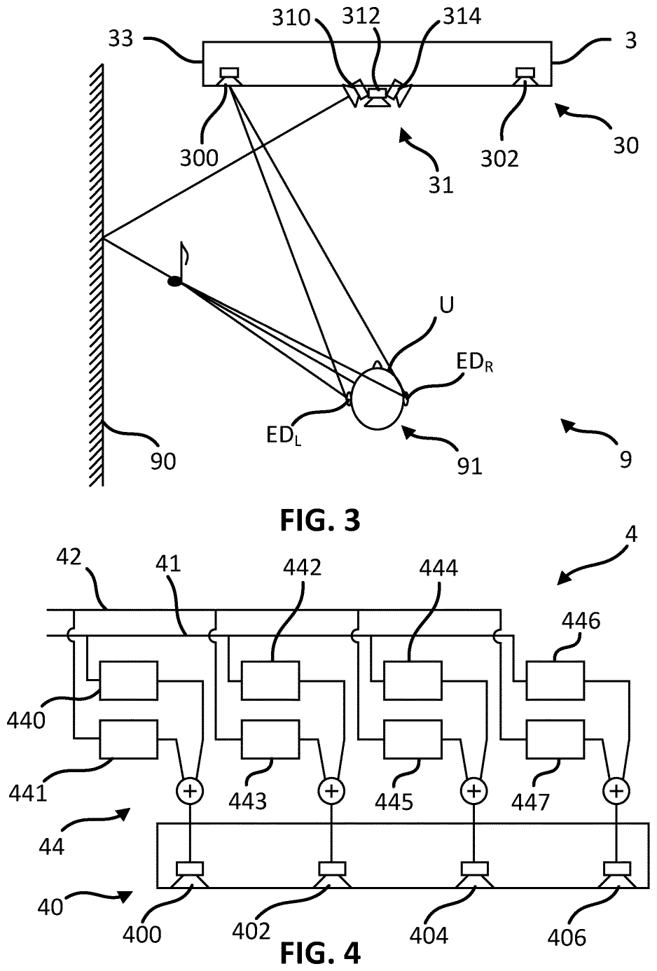

FIG. 3 shows a schematic illustration of an embodiment of an audio system 3 according to the present disclosure. The audio system 3 is arranged in a listening environment 9. The listening environment 9 comprises a wall 90 and an intended listening position 91. In FIG. 3, a listener U, having a left ear with a left eardrum ED_{L} and a right ear with a right eardrum ED_{R} is shown located in the intended listening position 91.

The audio system 3 comprises a plurality of loudspeaker units 30.

The plurality of loudspeaker units 30 comprises a first loudspeaker unit 300, a second loudspeaker unit 302, and a loudspeaker array 31. The loudspeaker array 31 comprises a plurality of array speaker units, comprising a first array speaker unit 310, a second array speaker unit 312, and a third array speaker unit 314.

The first speaker unit 300 is arranged at a first side, namely a left-hand side, of the intended listening position 91 in the listening environment 9 when the listener U has the predetermined listening orientation.

The second speaker unit 302 is arranged at a second side, namely a right-hand side, of the intended listening position 91 in the listening environment 9 when the listener U has the predetermined listening orientation.

The first array speaker unit 310 is arranged to project sound towards the first side to provide a beam of sound to be reflected by the wall 90 of the listening environment 9. The wall 90 is arranged at the first side of the intended listening position 91. The second array speaker unit 312 is arranged to project sound towards the intended listening position 91, whereas the third array speaker unit 314 is arranged to project sound towards the second side. The first 310, second 312, and third 314 array speaker units are collocated, i.e. in the present example located so that their sound emitting portions or surfaces are located within half a wavelength of a frequency in the frequency range of the audio to be applied the active beamforming processing by the array speaker units 310, 312, 314. In some examples, this may be a lower or lowermost frequency of the second, higher frequency band. It is noted that passive beamforming may, alternatively or additionally, be utilised for a subset of the frequencies of the second, higher frequency range. Passive beamforming will generally be understood as a beamforming based, at least in part, on or resulting, at least in part, from a directivity and/or size of a dimension of the loudspeaker unit(s). Correspondingly, beamforming as a combination of active beamforming and passive beamforming, at least for certain frequencies in the second, higher frequency range, or active beamforming for a subset of the frequencies in the second, higher frequency range and passive beamforming for a, potentially different, subset of the frequencies of the second, higher frequency range may be utilised. For passive beamforming, the speaker units may or may not be located within half a wavelength of a frequency in the frequency range of the audio to be applied the active beamforming processing by the array speaker units, such as the lower or lowermost frequency of the second, higher frequency band.

While the sound reflections off of the wall 90 as illustrated in FIG. 3 are generated by the first array speaker unit 310, it will be appreciated that in this and other embodiments, the reflections may be caused by the loudspeaker array, such as the combination of some or all of the array loudspeakers 310, 312, 314 in the loudspeaker array 31, and/or the plurality of loudspeakers 30, such as the combination of some or all of the plurality of loudspeakers 30. Such reflections off the wall 90 may be caused by the active beamforming processing so that the beamforming audio signals are indicative of and/or cause sound to be reflected off of the wall 90 when played back by the loudspeaker array 31 and/or the plurality of loudspeakers 30.

In the example shown in FIG. 3, the wall 90 is a side wall. In other embodiments, the listening environment 9 may be a room, such as a rectangular room, and comprise a plurality of walls including the side wall 90 and an opposing side wall (not shown). The audio system 3 may further be configured to cause sound to be reflected off of any opposing side wall in addition to the reflections off of the side wall 90, e.g. by the active beamforming processing and the plurality of loudspeakers 30, such as the loudspeaker array 31, in a manner similar to the sound reflections of the side wall 90.

In FIG. 3, projected sound from the first loudspeaker unit 300 to each of the left eardrum ED_{L} and the right eardrum ED_{R} of the listener U are illustrated. This illustrates the transfer functions H_{D1L} and H_{D1R}, respectively, from the first loudspeaker unit to each of the left ED_{L} and right ED_{R} eardrums. Similar transfer functions exist for the second loudspeaker unit 302 and each of the array speaker units 310, 312, 314, however not illustrated in FIG. 3 for simplicity.

In FIG. 3, a musical note further illustrates an intended location of an acoustic source of an audio signal.

The audio system 3 comprises the audio processing device 20 (not shown in FIG. 3). The audio processing device 20 is operably connected to each of the loudspeaker units 300, 302, 310, 312, 314. The audio processing device 20 is configured to perform crosstalk cancellation processing so that, in the first, lower frequency band, the audio of the acoustic source illustrated by the music note to the listener U appears to originate from the location indicated by the musical note shown in FIG. 3.

The audio processing device 20 is further configured to perform active beamforming processing so that, in the second, higher frequency band, the audio of the acoustic source illustrated by the music note to the listener U appears to originate from the location indicated by the musical note shown in FIG. 3. This is achieved by utilising the reflection of the audio illustrated from the first array speaker unit 310 off the wall 90 to the listener U.

The audio system 3 further comprises a housing 33 housing the array speaker units 310, 312, 314 of the loudspeaker array 31 as well as the first 300 and second loudspeaker units 302. The housing may further house the audio processing device 20 as well as any amplifiers, similar to amplifier module 21 of audio system 2.

FIG. 4 shows an exemplary block diagram of an embodiment of an audio system 4 according to the present disclosure.

The audio system 4 comprises a plurality of loudspeaker units 40, comprising a first loudspeaker unit 400, a second loudspeaker unit 402, a third loudspeaker unit 404, and a fourth loudspeaker unit 406.

The audio system 4 receives an audio signal comprising a first audio channel 41 and a second audio channel 42.

The audio system 4 further comprises a plurality of filters 44. The plurality of filters 44 generate the crosstalk cancellation audio signals and the active beamforming signals for each of the plurality of loudspeaker units 40 and output these to the respective loudspeaker units 40.

In the embodiment shown in FIG. 4, the plurality of filters 44 comprises a first filter 440 and a second filter 441, each having a respective filter function. The first filter 440 receives and applies the filter function to the first audio channel 41. Similarly, the second filter 441 receives the second audio channel 42 and applies the filter function to the first audio channel 42. The signals 41, 42 applied the functions of the first 440 and second 441 filters, respectively, are summed and provided to the first loudspeaker unit 400.

Similarly, a third filter 442 receives and applies a respective filter function to the first audio channel 41 and a fourth filter 443 receives the second audio channel 42 and applies a respective filter function to the second audio channel 42. The signals 41, 42 applied the functions of the third 442 and fourth 443 filters, respectively, are summed and provided to the second loudspeaker unit 402.

This equally applies to the third loudspeaker unit 404, for which a fifth filter 444 receives and applies a respective filter function to the first audio channel 41 and a sixth filter 445 receives the second audio channel 42 and applies a respective filter function to the second audio channel 42 and the sum of the signals 41, 42 applied the functions of the fifth 444 and sixth 445 filters is provided to the third loudspeaker unit 404.

This equally applies to the fourth loudspeaker unit 406, for which a seventh filter 446 receives and applies a respective filter function to the first audio channel 41 and an eighth filter 447 receives the second audio channel 42 and applies a respective filter function to the second audio channel 42 and the sum of the signals 41, 42 applied the functions of the seventh 446 and eighth 447 filters is provided to the fourth loudspeaker unit 406.

The plurality of filters 44 and/or their functionality may be embodied in and/or performed by the audio processing device 20, such as the processing unit 200 thereof.

The plurality of filters 44 provide crosstalk cancellation processing and active beamforming processing.

Where the plurality of loudspeaker units 40 comprise more loudspeaker units and/or where the audio signal includes more channels, the plurality of filters 44 may comprise further filters.

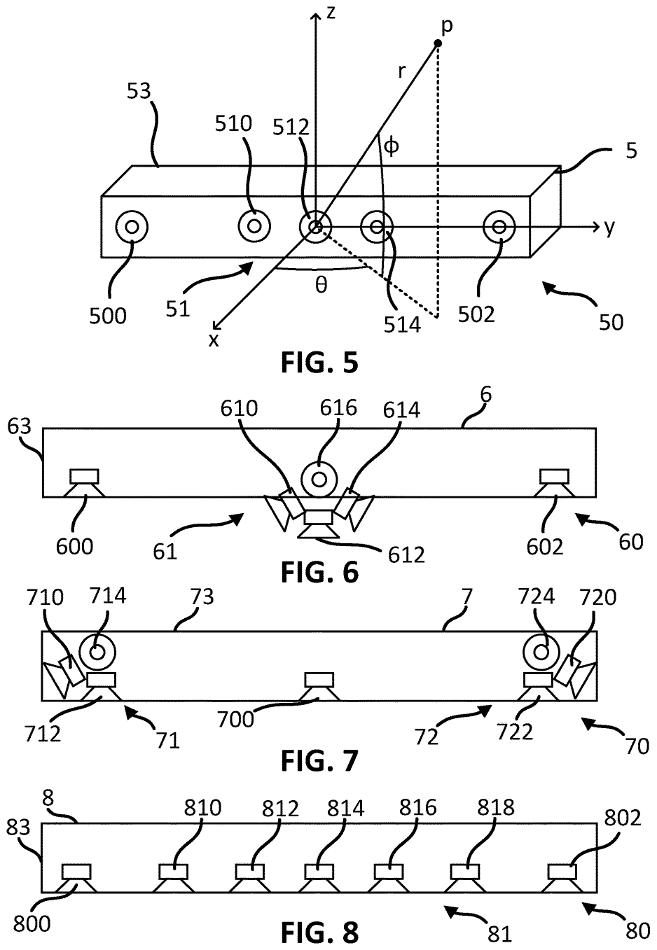

FIG. 5 shows a schematic illustration of an embodiment of an audio system according to the present disclosure.

The audio system 5 comprises, similar to audio system 3, a plurality of loudspeaker units 50 housed in a housing 53. The plurality of loudspeaker units 50 comprises a first loudspeaker unit 500, similar to the first loudspeaker unit 300, and a second loudspeaker unit 502, identical to the second loudspeaker unit 302. Similarly, the audio system comprises the audio processing device 20 (not shown) operably connected to each of the plurality of loudspeaker units 50.

The plurality of loudspeaker units 50 further comprises a loudspeaker array 51, comprising a first array speaker unit 510, a second array speaker unit 512, and a third array speaker unit 514.

In FIG. 5, a point p is illustrated in the listening environment. Audio transmitted from the second array speaker unit 512 is illustrated in cartesian coordinates having axes x, y, and z as well as in spherical coordinates, r, θ, and φ.

The transfer function from the second array speaker 512 unit to the point p is, thus, as expressed in spherical coordinates w₂H_{D2θφ}, where w₂ is a frequency dependent complex gain applied to the input signal before sending it to the second array loudspeaker unit.

A transfer function H_{Pθφ}, from, e.g., the loudspeaker array 51 to the point p as expressed in polar coordinates can for the point p be expressed as

$${H}_{P θφ} = {\sum }_{i = 1}^{N} {W}_{i} {H}_{Di θφ}$$

Here “i” indicate the i'th loudspeaker unit of at least the loudspeaker array speaker units 510-514. While only illustrated in FIG. 5 with respect to the second array speaker unit, similar equations can be set up for, e.g., the first 510 and third array speaker units 514. The transfer functions are, in this example, defined independently of a distance from the respectively loudspeaker array speaker units 510-514 due to the assumption of far-field conditions.

Here wᵢ is a frequency dependent complex gain applied to the input signal before sending it to the i'th loudspeaker unit. By means of active beamforming processing, the respective weights wᵢ for each array loudspeaker unit 510, 512, 514 are determined in accordance with a desired location of an acoustic source in the audio signal.

FIG. 6 shows a schematic illustration of an embodiment of an audio system 6 according to the present disclosure.

The audio system 6 comprises, similar to audio system 3, a plurality of speaker units 60 and the audio processing device 20 (not shown) operably connected to each of the loudspeaker units. The plurality of speaker units 60 as well as the audio processing device 20 are arranged in housing 63.

The plurality of loudspeaker units 60 comprises a first loudspeaker unit 600, identical to the first loudspeaker unit 300, and a second loudspeaker unit 602, identical to the second loudspeaker unit 302.

The plurality of loudspeaker units 60 further comprises a loudspeaker array 61. The loudspeaker array 61 comprises a first array speaker unit 610 facing and firing towards a first side, similar to first array speaker unit 310, a second array speaker unit 612 facing and firing towards the front, similar to second array speaker unit 312, and a third array speaker unit 614 facing and firing towards a second side, similar to the second array speaker unit 314. The loudspeaker array 61 further comprises an upward-firing speaker 616 facing and firing upwards.

FIG. 7 shows a schematic illustration of an embodiment of an audio system 7 according to the present disclosure.

The audio system 7 comprises, similar to audio system 3, a plurality of speaker units 70 and the audio processing device 20 (not shown) operably connected to each of the loudspeaker units. The plurality of speaker units 70 as well as the audio processing device 20 are arranged in housing 73.

The plurality of loudspeaker units 70 comprises a first loudspeaker unit 700 arranged centrally in the housing 73, facing and firing forwards.

The plurality of loudspeaker units 70 further comprises a first loudspeaker array 71 and a second loud speaker array 72. The first loud speaker array 71 is arranged at a first side of the audio system 7 whereas the second loudspeaker array 72 is arranged at a second, opposite side of the audio system 7.

The first loudspeaker array 71 comprises a first array speaker unit 710 facing and firing towards a first side, similar to first array speaker units 310 and 610. The first loudspeaker array 71 further comprises a forward-facing and firing second array speaker unit 712, similar to second array speaker units 312 and 612, and an upward-firing third array speaker unit 714, similar to fourth array speaker unit 616.

The second loudspeaker array 72 comprises a fourth array speaker unit 720 facing and firing towards a second side, similar to third array speaker units 314 and 614. The second loudspeaker array 72 further comprises a forward-facing and firing fifth array speaker unit 722, similar to second array speaker units 312, 612 and 712, and an upward-firing sixth array speaker unit 724, similar to fourth array speaker unit 616 and third array speaker unit 714.

FIG. 8 shows a schematic illustration of an embodiment of an audio system 8 according to the present disclosure.

The audio system 8 comprises, similar to audio system 3, a plurality of speaker units 80 and the audio processing device 20 (not shown) operably connected to each of the loudspeaker units. The plurality of speaker units 80 as well as the audio processing device 20 are arranged in housing 83.

The plurality of loudspeaker units 80 comprises a first loudspeaker unit 800, identical to the first loudspeaker unit 300, and a second loudspeaker unit 802, identical to the second loudspeaker unit 302.

The plurality of loudspeaker units 80 further comprises a loudspeaker array 81. The loudspeaker array 81 is illustrated as a line array similar to the loudspeaker array 51, but with five loudspeaker units rather than three. The loudspeaker array 81, thus, comprises a first array speaker unit 810, a second array speaker unit 812, a third array speaker unit 814, a fourth array speaker unit 816, and a fifth array speaker unit 818. Each of the first through fifth array speaker units 810-818 are forward-facing and firing.

Optionally, one of the array speaker units of the loudspeaker arrays mentioned herein may have an ornamental grille with a grid of 1,925 holes, the number referring to the year in which Bang & Olufsen® was founded.

Similar reference numerals are used for similar elements across the various embodiments and figures described herein.

### LIST OF REFERENCE NUMERALS

1 Method
   10 Method step
   11 Method step
   12 Method step
   13 Method step
   14 Method step
2 Audio system
   20 Audio processing device
      200 Processing unit
      202 Memory
   21 Amplifier
   22 Loudspeaker units
3 Audio system
   30 Loudspeaker units
      31 Loudspeaker array
         310 First array speaker unit
         312 Second array speaker unit
         314 Third array speaker unit
      300 First loudspeaker unit
      302 Second loudspeaker unit
   33 Housing
4 Audio system
   40 Loudspeaker units
      400 First loudspeaker unit
      402 Second loudspeaker unit
      404 Third loudspeaker unit
      406 Fourth loudspeaker unit
   41 First channel
   42 Second channel
   44 Filters
      440 First filter
      441 Second filter
      442 Third filter
      443 Fourth filter
      444 Fifth filter
      445 Sixth filter
      446 Seventh filter
      447 Eighth filter
5 Audio system
   50 Loudspeaker units
      51 Loudspeaker array
         510 First array speaker unit
         512 Second array speaker unit
         514 Third array speaker unit
      500 First loudspeaker unit
      502 Second loudspeaker unit
   53 Housing
6 Audio system
   60 Loudspeaker units
      61 Loudspeaker array
         610 First array speaker unit
         612 Second array speaker unit
         614 Third array speaker unit
         616 Fourth array speaker unit
      600 First loudspeaker unit
      602 Second loudspeaker unit
   63 Housing
7 Audio system
   70 Loudspeaker units
      71 First loudspeaker array
         710 First array speaker unit
         712 Second array speaker unit
         714 Third array speaker unit
      72 Second loudspeaker array
         720 Fourth array speaker unit
         722 Fifth array speaker unit
         724 Sixth array speaker unit
      700 First loudspeaker unit
   73 Housing
8 Audio system
   80 Loudspeaker units
      81 Loudspeaker array
         810 First array speaker unit
         812 Second array speaker unit
         814 Third array speaker unit
         816 Fourth array speaker unit
         818 Fifth array speaker unit
      800 First loudspeaker unit
      802 Second loudspeaker unit
   83 Housing
9 Listening environment
   90 Wall
   91 Intended listening position
U Listener
   ED_{L} Left ear drum
   ED_{R} Right ear drum
P calculation point
x First cartesian direction
y Second cartesian direction
z Third cartesian direction
r First polar coordinate
φ Second polar coordinate
θ Third polar coordinate

1. A computer-implemented method of processing audio to be played back by an audio system in a listening environment comprising an intended listening position and at least one wall, the audio system comprising a plurality of speaker units, wherein the method comprises:
receiving an audio signal to be played back,
dividing the audio signal into a first, lower frequency band and a second, higher frequency band,
generating, for each of the plurality of speaker units, a respective crosstalk cancellation audio signal by applying a crosstalk cancellation processing to the first, lower frequency band of the audio signal,
generating, for each of the plurality of speaker units, a respective beamforming audio signal by applying an active beamforming processing to the second, higher frequency band of the audio signal, wherein the beamforming audio signals are indicative of sound to be reflected off the at least one wall when output by the plurality of speaker units, and
outputting the crosstalk cancellation audio signals and beamforming audio signals for each of the plurality of speaker units for playback,
wherein the crosstalk cancellation processing and the active beamforming processing is applied based on location information indicating a location of the intended listening position in the listening environment relative to the plurality of speaker units.

2. The method according to claim 1, wherein applying the crosstalk cancellation processing comprises:
determining a respective desired sound pressure at a respective location of each of a left ear drum and a right ear drum of a user located in the intended listening position in accordance with a desired sound source location in the listening environment,
determining a respective sound pressure contribution to a total sound pressure at the locations of each of the left ear drum and the right ear drum of the user located in the intended listening position from each of the plurality of speaker units, wherein the plurality of speakers comprises at least one first speaker and at least one second speaker, and
determining a respective crosstalk cancellation weight value for each of the at least one first speaker and each of the at least one second speaker, wherein the respective crosstalk cancellation weights are determined so that a sum of the respective weights applied to the respective contributions from each of the at least one first speaker and each of the at least one second speaker approximates or equals the respective desired sound pressures at the respective locations of each of the left ear drum and the right ear drum of the user located in the intended listening position.

3. The method according to claim 1, wherein the active beamforming processing comprises:
determining, for a plurality of angular positions in the listening environment relative to the plurality of speaker units, a respective desired directivity of the plurality of speaker units,
determining, for each of the plurality of angular positions, a respective sound pressure contribution from each of the plurality of speaker units, and
determining a respective active beamforming weight for each of the plurality of speaker units so that a sound pressure in each of the plurality of directions are in accordance with the desired directivity of the plurality of speaker units.

4. The method according claim 1, wherein the first, lower frequency band has a lower frequency of at least 100 Hz.

5. The method according to claim 4, wherein the first, lower frequency band has a lower frequency of at least 250 Hz.

6. The method according to claim 1, wherein an upper frequency of the first, lower frequency band is at least 800 Hz.

7. The method according to claim 6, wherein the upper frequency of the first, lower frequency band is at least 1 kHz.

8. The method according to claim 1, wherein a lower frequency of the second, higher frequency band is at least 800 Hz.

9. The method according to claim 8, wherein the lower frequency of the second, higher frequency band is at least 1 kHz.

10. The method according to claim 1, wherein a lower frequency of the second, higher frequency band is below 5000 Hz.

11. The method according to claim 10, wherein the lower frequency of the second, higher frequency band is below 3000 Hz.

12. The method according to claim 4, wherein an audio processing unit is configured to determine an upper frequency of the first, lower frequency band based on one or more of: a distance from any one or more of the plurality of speaker units to the intended listening position, a distance from one or more of the plurality of speaker units to a wall in the listening environment, a wall response from one or more walls in the listening environment of a reflection of sound from one or more of the plurality of loudspeaker units, and a number of listeners in the listening environment.

13. The method according claim 8, wherein an audio processing unit is configured to determine the lower frequency of the second, higher frequency band based on one or more of: a distance from any one or more of the plurality of speaker units to the intended listening position, a distance from one or more of the plurality of speaker units to a wall in the listening environment, a wall response from one or more walls in the listening environment of a reflection of sound from one or more of the plurality of loudspeaker units, and a number of listeners in the listening environment.

14. An audio processing device for processing an audio signal to be played back by an audio system having a plurality of speaker units in a listening environment comprising an intended listening position and at least one wall, wherein the audio processing device comprises an audio processing unit configured to perform the method according to claim 1.

15. An audio system for playing back an audio signal in a listening environment, the audio system comprising:
a plurality of speaker units, and
an audio processing device according to claim 14 operably connected to the plurality of speaker units.

16. The audio system according to claim 15 further comprising a housing, wherein the housing houses the plurality of speaker units.

17. The audio system according to claim 15, wherein the plurality of speaker units comprises a loudspeaker array, comprising a plurality of array speaker units.

18. The audio system according to claim 15, wherein the audio system is a sound bar.
